(19) United States
(12) Patent Application Publication
(10) Pub. No.: US 2008/0089251 A1
(43) Pub. Date: Apr. 17, 2008

(54) Packet Data Transmission

(75) Inventors: Miguel Catalina Gallego, Valladolid (ES); David Garrec, Gif Sur Yvette Cedex (FR); Hong-Yon Lach, Charenton-le-pont (FR); Eric Melin, Montreal (CA)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/814,856

(22) PCT Filed: Jan. 31, 2006
(86) PCT No.: PCT/US06/03824

§ 371 Date: Jul. 26, 2007

(30) Foreign Application Priority Data
Feb. 17, 2005 (GB) 0503309.7

(51) Int. Cl. H04B 7/00

(52) U.S. Cl. 370/277

(57) ABSTRACT

A method and system, for transmitting data to a mobile node (4) over a unidirectional link (12) in a packet data network, for example an IP network, comprises: sending a message from a protocol address, e.g. IP address, of a bidirectional interface at the mobile node (4) to the home agent (6), the message comprising a protocol address of a unidirectional interface at the mobile node (4), wherein the protocol address of the bidirectional interface is different to the protocol address of the unidirectional interface; the home agent (6) transmitting data to the mobile node (4) using the protocol address of the unidirectional interface as the care-of-address; and delivering the transmitted data via the unidirectional link (12) to the unidirectional interface of the mobile node (4). The protocol address of the unidirectional interface may be contained in the message in the form of an extension appended to a registration.

### FIELD OF THE INVENTION

The present invention relates to routing data packets over links of a packet data network, such as an Internet Protocol (IP) network, to a mobile node.

### BACKGROUND OF THE INVENTION

Internet Protocol (IP) is a well established protocol for routing of data packets over packet data networks, for example the Internet. Examples of specific versions of IP are IPversion4 (IPv4) and IPversion6 (IPv6).

A protocol for supporting mobile nodes, e.g. mobile devices such as mobile telephones, portable computers with wireless connection functionality, and so on, under IP, is known as Mobile IP, in particular MobilelPv4 based on IPv4, and Mobile IPv6 based on IPv6.

The IP and Mobile IP protocols are standardised by the Internet Engineering Task Force (IETF). Details of MobileIPv4 can be found in IETF specification RFC 3344: “IP Mobility Support for IPv4”. Mobile IPv6 is described in David W. Johnson and Charles Perkins, Mobility Support in IPv6, Internet Draft, 2000. Further information on IPv6 can be found in IETF specification RFC 2460, 1998.

A mobile node can change location, e.g. change from being attached to one network or sub-network to being attached to another network or sub-network without changing its IP address. The mobile node continues, although at different locations, to communicate with other network nodes using its constant IP address. This is, broadly speaking, achieved as follows. The mobile node is associated with a home agent on a home network, where the mobile node is given a long-term IP address. When the mobile node is roaming, i.e. away from its home network, routing services are provided to the mobile node by a foreign agent at a network where the mobile node is temporarily located, say. The foreign agent detunnels and delivers, to the mobile node, datagrams that were tunnelled by the mobile node's home agent. For datagrams sent by the mobile node, the foreign agent may serve as a default router for registered mobile nodes. When away from its home network, a care-of address is associated with the mobile node and reflects the mobile node's current point of attachment.

Conventionally, IP and Mobile IP assumes that links between nodes, i.e. of interest here, links to a mobile node, are bidirectional, i.e. that directly connected nodes can communicate with each other in both directions over the same network link.

However, use of unidirectional links under IP is becoming more prevalent, for example unidirectional links such as satellite links or digital video broadcast transmission (DVB-T) data links. Solutions available under IP for accommodating unidirectional links are not generally applicable to a unidirectional link to a mobile node under Mobile IP when the mobile node is roaming, i.e. not connected to a home location.

The following approaches to using unidirectional links with mobile nodes have been disclosed.

The Uni-Directional Link Routing (UDLR) working group of IETF issued a mechanism and set of protocols that permit emulation of bidirectional connectivity over unidirectional links, based on an “interaction channel” being available at the mobile node. The mechanism comprises tunnelling packets from the mobile node unidirectional link to its home network using a link layer tunnel over the interaction channel. The tunnels are established and maintained dynamically using a Dynamic Tunnel Configuration Protocol specified in UDLR. However, this UDLR approach requires a complicated mechanism to be set up and requires a large degree of specialised processing when in use. For example, the use of two tunnels simultaneously requires repeated encapsulation and “detunneling”, as well as routing to be via a long inefficient path. Also, a large degree of overhead is present due to the use of tunnelling headers. Furthermore, this approach cannot be used with Network Address Translators (NAT), which are an increasingly used security feature that modify the source IP address of packets; this is because under the UDLR approach the mobile node is not reachable if it is behind a NAT.

WO 03/047183 discloses an approach for use with IPv6, using a primary care-of-address for a bidirectional link, and a secondary care-of-address for the unidirectional link; the approach being based on a standard Mobile IPv6 Binding Update/Binding Acknowledge mechanism. However, this requires significant alteration to the operation of the home agent, as usually a home agent only has to store and use one care-of-address for a mobile node.

WO 01/76286 discloses another approach for use with IPv6, using a primary care-of-address and a collocated care-of-address, one being the bidirectional link and one for the unidirectional link. Again, however, this requires significant alteration to the operation of the home agent, as usually a home agent only has to store and use one care-of-address for a mobile node.

WO 01/72076 discloses an approach for use with IPv4. The Mobile IPv4 implementation is not modified as such. Instead new software entities are added, being collocated on the home agent, the foreign agent and the mobile node. The software entities handle handover, including at least one unidirectional link. Thus significant alteration to the operation of the home agent, the foreign agent, the mobile node, and the operation of the system as a whole, is required.

### SUMMARY OF THE INVENTION

The present invention provides new ways of accommodating unidirectional links to a mobile node, and moreover these tend to avoid or alleviate the disadvantages mentioned above with respect to known approaches.

In a first aspect, the present invention provides a method for transmitting data to a mobile node over a unidirectional link in a packet data network, the method comprising: sending a message from a protocol address of a bidirectional interface at the mobile node to a home agent of the mobile node, the message comprising a protocol address of a unidirectional interface at the mobile node coupled to the unidirectional link, wherein the protocol address of the bidirectional interface is different to the protocol address of the unidirectional interface; the home agent transmitting data to the mobile node using the protocol address of the unidirectional interface as the care-of-address; and

delivering the transmitted data via the unidirectional link to the unidirectional interface of the mobile node.

In a further aspect, the present invention provides a method of operating a mobile node in a packet data network, the method comprising sending a message from a protocol address of a bidirectional interface at the mobile node to a home agent of the mobile node, the message comprising a protocol address of a unidirectional interface at the mobile node coupled to the unidirectional link, wherein the protocol address of the bidirectional interface is different to the protocol address of the unidirectional interface.

In a further aspect, the present invention provides a storage medium storing processor-implementable instructions for controlling a processor to carry out the method of the above mentioned aspects.

In a further aspect, the present invention provides a system for transmitting data over a unidirectional link in a packet data network, comprising: a mobile node and a home agent; the mobile node being arranged to send a message from a protocol address of a bidirectional interface at the mobile node to the home agent, the message comprising a protocol address of a unidirectional interface at the mobile node coupled to the unidirectional link, wherein the protocol address of the bidirectional interface is different to the protocol address of the unidirectional interface; and the home agent being arranged to transmit data to the mobile node using the protocol address of the unidirectional interface as the care-of-address.

In a further aspect, the present invention provides a mobile node for a packet data network; wherein the mobile node is arranged to send a message from a protocol address of a bidirectional interface at the mobile node to a home agent, the message comprising a protocol address of a unidirectional interface at the mobile node coupled to the unidirectional link, wherein the protocol address of the bidirectional interface is different to the protocol address of the unidirectional interface.

In a further aspect, a message informing of a unidirectional link care-of-address (or other proxy address) is sent to a home agent from a different bidirectional care-of-address (or other proxy address).

In each of the above aspects, the message may comprise the protocol address of the unidirectional interface hi the form of an extension appended to a registration request compliant with the protocol.

In each of the above aspects, the packet data network may be a Mobile IP network, in particular Mobile IPv4 or Mobile IPv6, and the protocol addresses may be IP addresses.

### BRIEF DESCRIPTION OF THE DRAWINGS

Embodiments of the present invention will now be described, by way of example only, with reference to the accompanying drawings, in which:

FIG. 1 is a schematic illustration of a network architecture 1 for operation of Mobile IP to which embodiments of the present invention may be applied;

FIG. 2 is a flowchart showing process steps employed by a process that enables Mobile IP to be used over a unidirectional link; and

FIG. 3 is a flowchart showing process steps employed by a further process that enables Mobile IP to be used over a unidirectional link

### DESCRIPTION OF THE DRAWINGS

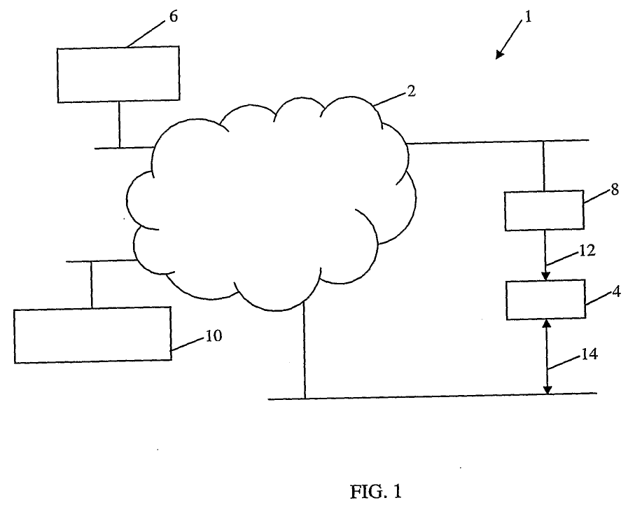

FIG. 1 is a schematic illustration of a network architecture 1 for operation of Mobile IP to which embodiments of the present invention may be applied. In this example the network architecture operates under Mobile IPv4, but in other examples Mobile IPv6, and indeed any other suitable protocols, may be used.

The network architecture 1 comprises a number of elements connected via the Internet 2. The elements are a mobile node 4, a home agent 6, a foreign agent (not shown), a unidirectional feed 8, and a correspondent node 10. There is a unidirectional link 12 from the unidirectional feed 8 to the mobile node 4. There is a bidirectional link from, and to, the mobile node 4.

The mobile node 4 is, in general, a host or router that can change location, e.g. change from being attached to one network or sub-network to being attached to another network or sub-network without changing its IP address. The mobile node has a receive-only unidirectional interface (in other embodiments the mobile node may have plural receive-only interfaces) and a bidirectional network interface (in other embodiments the mobile node may have plural receive-only interfaces).

The receive-only interface is capable of receiving Mobile IP Agent Advertisements, and thus it can acquire a foreign agent care-of address. However Mobile IP Registration Requests cannot be sent through the receive-only interface, nor can data packets be transmitted through the receive-only interface.

In this embodiment, the mobile node 4 is a 3rd generation mobile telephone with IP functionality for communicating over the Internet, and other related functionality, e.g. in this embodiment functionality for receiving and displaying digital video broadcast (DV) transmissions. However, it will be appreciated that in other embodiments the mobile node 4 may be any other appropriate host or router device, for example a portable computer with built-in, or added, wireless communication functionality.

A mobile node 4 has a long-term IP address, called home address, on its home network. Generally, in Mobile IP, when the mobile node 4 is away from its home network, a care-of-address is associated with the mobile node 4. The care-of-address reflects the current point of attachment of the mobile node 4.

The home agent 6 is a router on the home network of the mobile node 4. The home agent tunnels datagrams for delivery to the mobile node 4 when the mobile node 4 is away from its home network. To be able to do this, the home agent 6 maintains current location information for the mobile node 4. Generally speaking in Mobile IP, this current location information is based upon the care-of-address.

The foreign agent (not shown) is a router on the network visited by the mobile node 4. The foreign agent provides routing services to the mobile node 4 while the mobile node 4 is registered to the network served by the foreign agent. The home agent tunnels datagrams to the foreign agent. The foreign agent detunnels and delivers the datagrams to the mobile node 4.

The unidirectional feed 8 transmits data packets to the receive-only interface of the mobile node 4 over the unidirectional link 12. The unidirectional feed 8 may behave as an IP router or as a bridge.

The correspondent node 10 is, in this example, a node communicating with the mobile node, e.g. it is a network device sending a digital video streaming transmission to the mobile node 4.

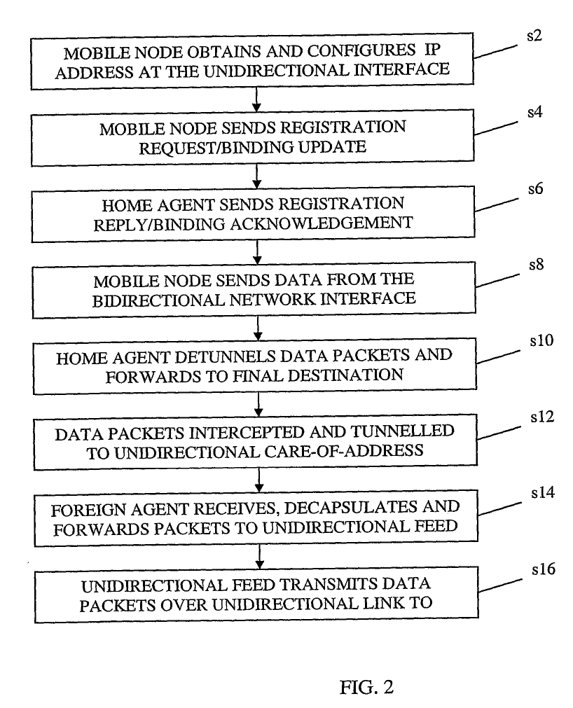

FIG. 2 is a flowchart showing process steps employed by a process according to this embodiment which enables Mobile IP to be used over the unidirectional link 12. (In this embodiment, Network Address Translators (NAT) Traversal is not implemented.)

At step s2, the mobile node 4 obtains and configures the IP address at the unidirectional interface, i.e. the IP address of the foreign agent on the same unidirectional link 12 as the unidirectional feed 8. The mobile node 4 may obtain this IP address by any suitable means compatible with Mobile IPv4 (or in other embodiments, for example, Mobile IPv6). In this Mobile IPv4 example, the address may be determined from Agent Advertisements provided by the foreign agent, the foreign agent being located in the same link as the unidirectional feed 8. (In the case of Mobile IPv6, stateless auto-configuration can be used: a router before the unidirectional link 12 sends router advertisements that are transmitted over the unidirectional link 12 by the unidirectional feed 8. The mobile node 4 receives the advertisements and configures an IP address using the advertised network prefix and its own interface identifier.) Alternatively, any other suitable way of obtaining the IP address may be used, for example other external mechanisms, e.g. an external mechanism such as Dynamic Host Configuration Protocol (DHCP).

The obtained IP address at the unidirectional interface is then used as the primary care-of-address; i.e. at step s4, the mobile node 4 sends, to the home agent 6, a Mobile IPv4 Registration Request (in mobile IPv6 embodiments this is instead a Binding Update) in which the obtained IP address at the unidirectional interface is used as the primary care-of-address. The Registration Request (in IPv6 the Binding Update) (hereinafter referred to as the Registration Request/Binding Update) is sent over the bidirectional link 14 from the bidirectional network interface of the mobile node 4. Note therefore that, at step s4, the Registration Request/Binding Update is sent from a different IP address (namely the IP address of the bidirectional interface) compared to the IP address (namely the IP address of the unidirectional interface) provided to the home agent 6 for use by the home agent 6 as the care-of-address for the mobile node 4; (also note in this embodiment the source address of the Registration Request/Binding Update is different to the address used in the Registration Request/Binding Update).

After receiving the Registration Request/Binding Update, at step s6, the home agent 6 sends a Registration Reply/Binding Acknowledgement to the bidirectional interface, i.e. to the source address of the Registration Request/Binding Update.

At step s8, the mobile node 4 sends data from the bidirectional network interface. In particular, data packets sent from the mobile node 4 to the correspondent node 10 are encapsulated in a tunnel to the home agent 6. Step s8 is optional, in the sense that if there is no data to be sent this step need not take place.

At step s10 the home agent detunnels the data packets and forwards them to their final destination, e.g. the correspondent node 10.

At step s12, data packets sent to the mobile node 4 are intercepted by the home agent 6 and then tunnelled to the unidirectional care-of-address, since this is the care-of-address held by the home agent 6 for the mobile node 4. In this example the data packets are digital video streaming transmission packets being set to the mobile node 4 from the correspondent node 10.

At step s14, the foreign agent receives the packets, decapsulates the packets, and then forwards the packets to the unidirectional feed 8.

At step s16, the unidirectional feed 8 transmits the data packets over the unidirectional link 12 to the mobile node 4.

(Note steps s8 and s12 may occur in reverse order or in an overlapping fashion depending on what data is being sent in each direction, but are described in the above order in simplified form to allow the benefits of presenting the process in the form of a flowchart diagram.)

Thus the above described process allows the mobile node 4 to receive Mobile IP data through the over the unidirectional link 12 and further allows he mobile node to use the bidirectional link 14 as a return path.

This is achieved without the need for any extra tunnelling compared to conventional Mobile IP processes.

Also, the process (with appropriate variation) can be applied to Mobile IPv4 and Mobile IPv6.

Furthermore, the mobile node 4 can roam from one unidirectional link to another.

Also, the mobile node 4 can perform vertical handover between a unidirectional interface and a bidirectional interface, even if the bidirectional interface is the return path.

If the mobile node 4 has multiple bidirectional interfaces, any of them can be used for the return path of the unidirectional interface. It is also possible to switch the return path interface.

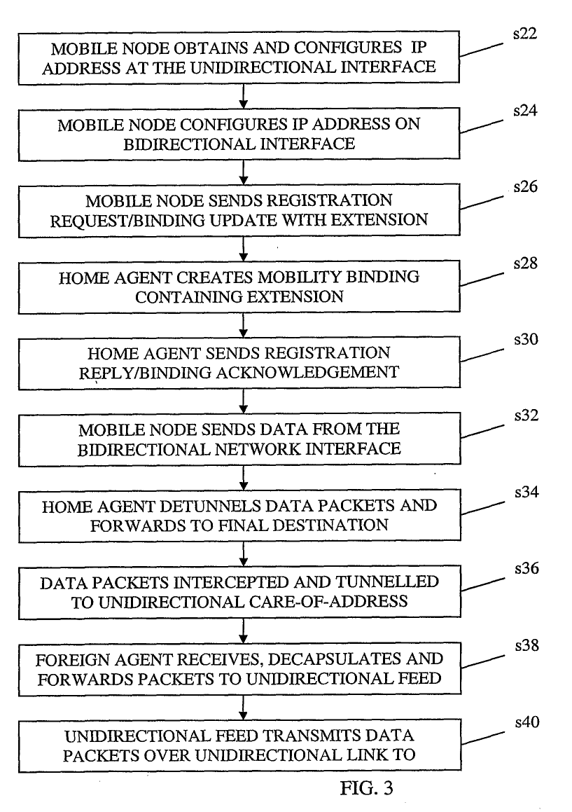

A further embodiment will now be described with reference to FIG. 3. FIG. 3 is a flowchart showing process steps employed by the further embodiment to provide an alternative process for implementing the sending of a Registration Request (Mobile IPv4)/Binding Update (Mobile IPv6) from a different IP address compared to the IP address provided to the home agent 6 for use by the home agent 6 as the care-of-address for the mobile node 4. As such, the advantages that tend to arise from implementation of the above described first embodiment also tend to arise when the following embodiment is implemented. Furthermore, the following embodiment has a further specific advantage in that it can be implemented even with the Mobile IP NAT traversal standard, i.e. when the mobile node 4 is behind a NAT.

Referring to FIG. 3, at step s22, the mobile node 4 obtains and configures the IP address at the unidirectional interface, i.e. the IP address of the foreign agent on the same unidirectional link 12 as the unidirectional feed 8. The mobile node 4 may obtain this IP address by any suitable means compatible with Mobile IPv4 (or in other embodiments, for example, Mobile IPv6). In this Mobile IPv4 example, the address may be determined from Agent Advertisements provided by the foreign agent, the foreign agent being located in the same link as the unidirectional feed 8. (In the case of Mobile IPv6, stateless auto-configuration can be used: a router before the unidirectional link 12 sends router advertisements that are transmitted over the unidirectional link 12 by the unidirectional feed 8. The mobile node 4 receives the advertisements and configures an IP address using the advertised network prefix and its own interface identifier.) Alternatively, any other suitable way of obtaining the IP address may be used, for example other external mechanisms, e.g. an external mechanism such as Dynamic Host Configuration Protocol (DHCP).

At step s24, the mobile node 4 configures an IP address on its bidirectional interface, in conventional manner. Either a collocated addresses (obtained via DHCP or stateless auto-configuration, for instance), or a foreign agent address, may be used for the bidirectional interface. If the mobile node 4 has plural bidirectional interfaces, it may optionally configure plural IP addresses.

If the mobile node 4 has plural unidirectional interfaces or plural bidirectional interfaces then the mobile node 4 selects the unidirectional interface that it wants to use and the bidirectional interface to be used as return path. Then, at step s26, the mobile node 4 sends, to the home agent 6, a Mobile IPv4 Registration Request (in mobile IPv6 embodiments this is instead a Binding Update) through the bidirectional interface, using the IP address of the bidirectional interface as the source address for this message. The Registration Request (in IPv6 the Binding Update) (hereinafter referred to as the Registration Request/Binding Update) contains the following details:
(a) the primary care-of address in the Registration Request/Binding Update) is set to the address of the bidirectional interface; and
(b) a special extension, which may conveniently be called “Unidirectional Care-of Address extension” is appended to the Registration Request/Binding Update in addition to the UDP Tunnel Request extension defined in the NAT Traversal standard (i.e. in this embodiment NAT is thereby accommodated, but if there is no requirement to accommodate NAT then the remainder of this embodiment can be used accordingly without using the UDP Tunnel request extension). The Unidirectional Care-of Address extension contains the care-of address of the unidirectional interface.

After the home agent 6 has received the Registration Request/Binding Update containing the Unidirectional Care-of Address extension, at step s28 the home agent 6 creates a mobility binding. This mobility binding contains:
(a) the return-path care-of address, that is, the IP address of the bidirectional interface in the mobile node—this was the source address of the Registration Request/Binding Update; and
(b) the unidirectional care-of address, that is, the IP address of the foreign agent on the same link as the unidirectional feed 8. This is the address specified in the Unidirectional Care-of Address extension of the Registration Request/Binding Update.

At step s30, the home agent 6 sends a Registration Reply/Binding Acknowledgement to the bidirectional interface, i.e. to the source address of the Registration Request/Binding Update.

At step s32, the mobile node 4 sends data from the bidirectional network interface. In particular, data packets sent from the mobile node 4 to the correspondent node 10 are encapsulated in a tunnel to the home agent 6. Step s32 is optional, in the sense that if there is no data to be sent this step need not take place.

A step s34, the home agent detunnels the data packets and forwards them to their final destination, e.g. the correspondent node 10.

At step s36, data packets sent to the mobile node 4 are intercepted by the home agent 6 and then tunnelled to the unidirectional care-of-address, since this is the care-of-address held by the home agent 6 for the mobile node 4. In this example the data packets are digital video streaming transmission packets being set to the mobile node 4 from the correspondent node 10.

At step s38, the foreign agent receives the packets, decapsulates the packets, and then forwards the packets to the unidirectional feed 8.

At step s40, the unidirectional feed 8 transmits the data packets over the unidirectional link 12 to the mobile node 4.

(Note steps s32 and s36 may occur in reverse order or in an overlapping fashion depending on what data is being sent in each direction, but are described in the above order in simplified form to allow the benefits of presenting the process in the form of a flowchart diagram.)

It will be appreciated that if the mobile node 4 is behind a NAT, the home agent 6 keeps two tunnels instead of one for the mobile node 4 when it is using the unidirectional link 12. One tunnel is used to send data to the mobile node 4, and the other is used to receive data from it.

Also, it will be appreciated that, as in the case of the first embodiment described earlier above with reference to FIG. 2, the Registration Request/Binding Update is sent from a different IP address (namely the IP address of the bidirectional interface) compared to the IP address (namely the IP address of the unidirectional interface) provided to the home agent 6 for use by the home agent 6 as the care-of-address for the mobile node 4.

The above embodiments are applied in a network arrangement including the Internet, but the invention may be applied to any appropriate packet switched network, for example an intranet.

Also, although the embodiments are described in relation to Mobile IPv4 and Mobile IPv6, the invention may be applied to other versions of IP. The invention may also be applied to other packet switching protocols that support mobility in a fashion that allows a message informing of a unidirectional link care-of-address (or other proxy address) to be sent to a home agent from a different bidirectional care-of-address (or other proxy address). For example, in the above embodiments the message sent to the home agent informing the home agent of the unidirectional care of address to be used for the unidirectional link is a Registration Request in the case of Mobile IPv4 and a Binding Update in the case of Mobile IPv6. However, in embodiments applied to packet switching protocols other than IP, other appropriate types of messages will be used for this purpose.

The above embodiments may be implemented by configuring or adapting any suitable apparatus, for example conventional mobile nodes such as mobile telephones and portable computers, and, where required, conventional equipment and software providing a conventional home agent. Alternatively, or in addition, the processes described may be implemented by processor-implementable instructions implemented by a processor and/or stored on a suitable storage medium, such as computer memory, hard disk, floppy disk, ROM, PROM etc.

1. A method for transmitting data to a mobile node over a unidirectional link in a packet data network, the method comprising:
sending a message from a protocol address of a bidirectional interface at the mobile node to a home agent of the mobile node, the message comprising a protocol address of a unidirectional interface at the mobile node coupled to the unidirectional link, wherein the protocol address of the bidirectional interface is different to the protocol address of the unidirectional interface;
the home agent transmitting data to the mobile node using the protocol address of the unidirectional interface as the care-of-address; and
delivering the transmitted data via the unidirectional link to the unidirectional interface of the mobile node.

2. A method of operating a mobile node in a packet data network, the method comprising sending a message from a protocol address of a bidirectional interface at the mobile node to a home agent of the mobile node, the message comprising a protocol address of a unidirectional interface at the mobile node coupled to the unidirectional link, wherein the protocol address of the bidirectional interface is different to the protocol address of the unidirectional interface.

3. A method according to claim 1, wherein the message comprises the protocol address of the unidirectional interface in the form of an extension appended to a registration request compliant with the protocol.

4. A method according to claim 1, wherein the packet data network is a Mobile IP network and the protocol addresses are IP addresses.

5. (canceled)

6. A system for transmitting data over a unidirectional link in a packet data network, comprising:
a mobile node and a home agent;
the mobile node being arranged to send a message from a protocol address of a bidirectional interface at the mobile node to the home agent, the message comprising a protocol address of a unidirectional interface at the mobile node coupled to the unidirectional link, wherein the protocol address of the bidirectional interface is different to the protocol address of the unidirectional interface; and
the home agent being arranged to transmit data to the mobile node using the protocol address of the unidirectional interface as the care-of-address.

7. A system according to claim 6, wherein the message comprises the protocol address of the unidirectional interface in the form of an extension appended to a registration request compliant with the protocol.

8. A system according to claim 6, wherein the packet data network is a Mobile IP network and the protocol addresses are IP addresses.

9. A mobile node for a packet data network;
wherein the mobile node is arranged to send a message from a protocol address of a bidirectional interface at the mobile node to a home agent, the message comprising a protocol address of a unidirectional interface at the mobile node coupled to the unidirectional link, wherein the protocol address of the bidirectional interface is different to the protocol address of the unidirectional interface.

10. A mobile node according to claim 9, wherein the message comprises the protocol address of the unidirectional interface in the form of an extension appended to a registration request compliant with the protocol.

11. A mobile node according to claim 9, wherein the packet data network is a Mobile IP network and the protocol addresses are IP addresses.
